(19) United States
(12) Patent Application Publication
(10) Pub. No.: US 2005/0071112 A1
(43) Pub. Date: Mar. 31, 2005

(54) Method and apparatus for channel-based testing

(75) Inventors: Jeff C. Morriss, Cornelius, OR (US); Richard Mellitz, Irmo, SC (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/674,593

(22) Filed: Sep. 29, 2003

(51) Int. Cl. G01M 19/00

(52) U.S. Cl. 702/124

(57) ABSTRACT

A reference channel is coupled to a device under test and measurements are made at the output of the reference channel.

### FIELD

The present invention relates generally to testing electronics, and more specifically to testing communications systems.

### BACKGROUND

A communications link can be partitioned into components such as a transmitter, a channel, and a receiver. Testing of the various components is typically performed to guarantee interoperability when the components are combined in a system. For example, testing may involve measuring various parameters of transmitters, channels, and receivers, and comparing the parameter values to acceptable limits as published in an interface specification.

As communication speeds have increased, the number and complexity of measured parameters has also increased. For example, parameters typically measured when testing a transmitter may include rise time, fall time, voltage levels, jitter, and others. Likewise, the number and complexity of measured parameters for other components may also be high. Tolerances, or “guardbands,” for various parameters of different components may be additive, and may reduce the design space available to component designers.

### BRIEF DESCRIPTION OF THE DRAWINGS

FIG. 1 shows a diagram of a channel under test;

FIG. 2 shows a plot of loss versus frequency for a channel under test and a reference channel;

FIG. 3 shows a diagram of a transmitter under test;

FIGS. 4 and 5 show diagrams of circuits that support testing of a receiver;

FIG. 6 shows a diagram of a channel under test and an aggressor channel;

FIG. 7 shows a plot of loss versus frequency;

FIG. 8 shows a plot of delay versus frequency;

FIG. 9 shows a system diagram in accordance with various embodiments of the present invention; and

FIGS. 10-12 show flowcharts of methods in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

FIG. 1 shows a diagram of a channel under test. Included in FIG. 1 are channel under test 102, vector network analyzer (VNA) port 104, and VNA port 106. VNA ports 104 and 106 may be used to drive a signal through channel under test 102 and measure the signal at the opposing end. For example, VNA port 104 may drive a sine wave signal that is swept in frequency, and VNA port 106 may measure the signal. Also for example, VNA port 104 may drive a pulsed signal that includes multiple frequencies, and VNA port 106 may measure the signal. Channel under test 102 is shown as a differential channel having two input nodes and two output nodes, although the invention is not limited in this regard. Channels under test may be single-ended, differential, or any other type of suitable channel.

VNA ports 104 and 106 may be ports on a vector network analyzer, but this is not a limitation of the present invention. For example, in some embodiments, any type of test equipment may be used to drive a signal through channel under test 102, and any type of test equipment may be used to measure the signal at the opposing end. Further, in some embodiments, reference channel 102 is defined as a software model, and VNA ports 104 and 106 are implemented in software. These embodiments and other embodiments are described more fully below.

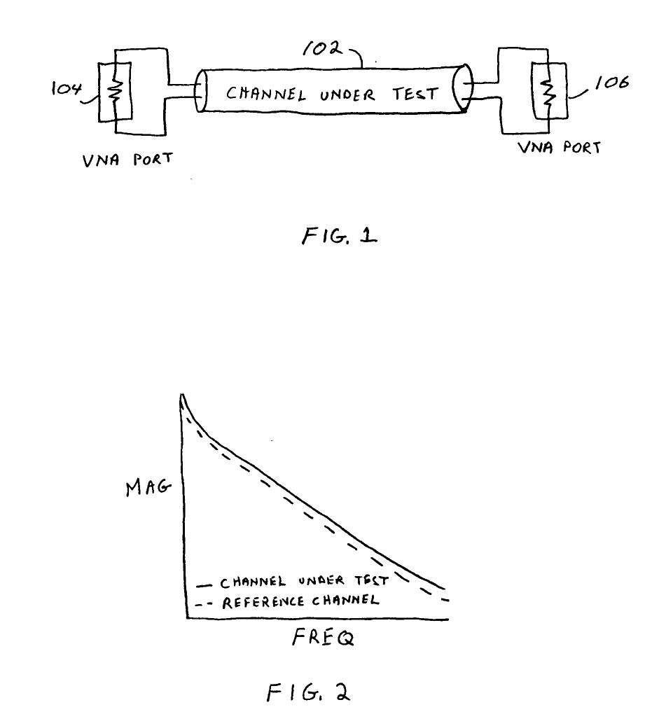

FIG. 2 shows a plot of loss versus frequency for a channel under test and a reference channel. The vertical axis shows signal magnitude (MAG), and the horizontal axis shows frequency (FREQ). As shown in FIG. 2, a “reference channel” is defined by the dashed line. The reference channel is defined as a worst-case channel that displays a maximum allowable loss versus frequency characteristic. When compared against the reference channel, a channel under test passes the test if its loss versus frequency curve lies above that of the reference channel over some frequency range. The reference channel may be specified in many different ways, including a loss versus frequency plot, or a matrix of s-parameters.

As shown in the various figures and described with reference thereto, transmitters, receivers, and channels can be tested in conjunction with, or in comparison to, the reference channel.

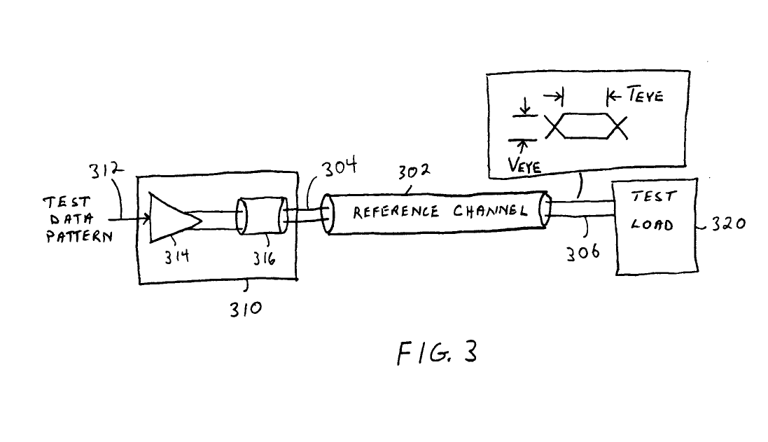

FIG. 3 shows a diagram of a transmitter under test. Transmitter 310 is coupled to reference channel 302 at nodes 304. Reference channel 302 is, in turn, coupled to test load 320 at nodes 306. Test load 320 may be a resistive load, but this is not a limitation of the present invention. Transmitter 310 is a transmitter under test, also referred to as a “device under test” (DUT).

Transmitter 310 includes driver 314 and conductor 316. Conductor 316 is shown schematically to indicate that any integrated circuit or package wiring may have an effect on a signal output from driver 314. Transmitter 310 includes an input node 312, which is driven by a test data pattern. In some embodiments, the test data pattern is a “compliance data pattern” defined in a specification. The test data pattern may be specified to produce worst-case or near worst-case conditions for testing transmitter 310.

Transmitter 310 may be tested by applying the test data pattern to an input node of transmitter 310, and then performing measurements across test load 320 at nodes 306. In some embodiments, the measurements include an eye voltage (shown as V_{EYE}) and an eye time (shown as T_{EYE}). If the measurements meet previously defined minimum requirements, then transmitter 310 passes the test.

In some embodiments, a single eye voltage and a single eye time are measured. For example, if a signal has two possible values represented as two separate voltage levels, a single voltage and a single time may be measured. In other embodiments, multiple voltages or times may be measured. For example, if a signal has four possible values represented as four separate voltage levels, voltages corresponding to three vertically stacked eyes may be measured. The present invention is not limited by the number or type of measured parameters.

In some embodiments of the present invention, a transmitter may be tested by performing measurements at the output of a reference channel rather than performing measurements directly at the transmitter boundary. For example, as shown in FIG. 3, transmitter under test 310 is tested by coupling it to reference channel 302, and measuring the output of the reference channel.

Coupling a transmitter to a reference channel and performing the measurement as indicated in FIG. 3 may be performed in many ways. For example, in some embodiments, a physical channel that corresponds in behavior to the reference channel may be physically coupled between a transmitter under test and a test load. In other embodiments, testing of a transmitter may be performed using software simulation. In these embodiments, the reference channel may be specified using a software model such as an s-parameter matrix, and the transmitter under test may be specified using a software model created using design automation software. Any combination of simulation and physical measurements may be utilized without departing from the scope of the present invention.

In embodiments using software models, a transmitter designer or driver designer may test the transmitter using simulation by coupling conductor 316 (to model interconnect effects) between driver 314 and reference channel 302, coupling test load 320 to the output of reference channel 302, driving the software model with a test data pattern, and measuring the output of the reference channel in software.

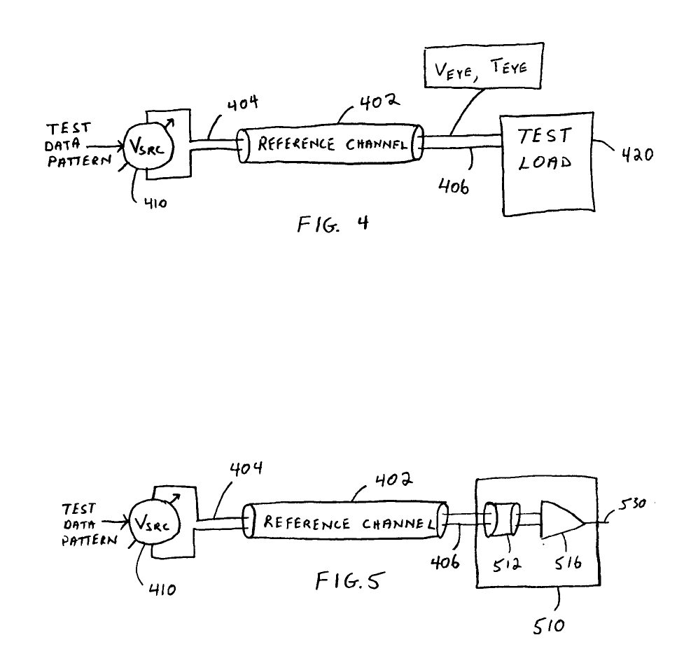

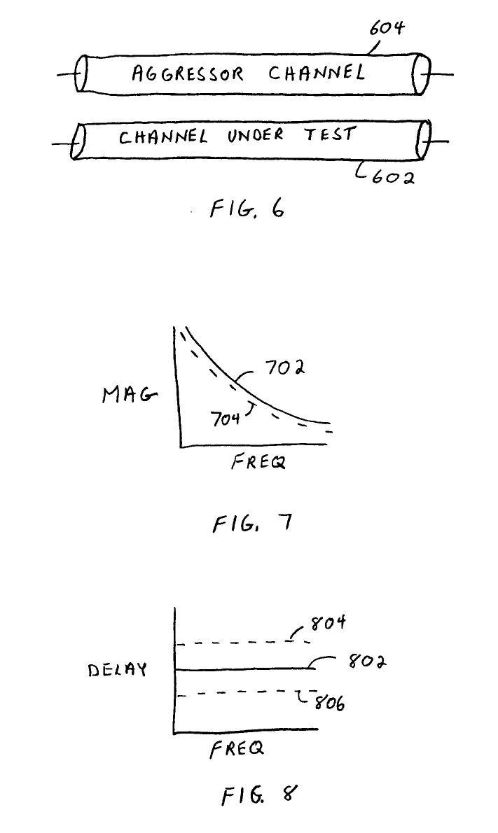

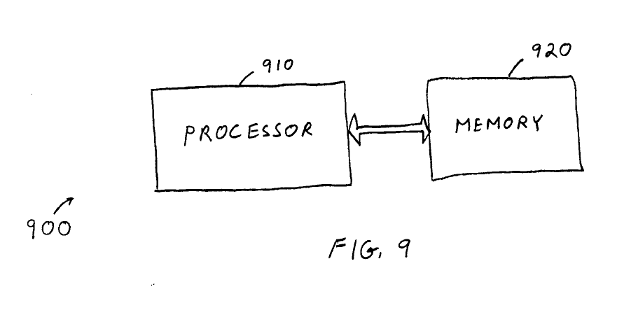

FIGS. 4 and 5 show diagrams of circuits that support testing of a receiver. Referring to FIG. 4, reference channel 402 is coupled between variable source (V_{SRC}) 410 and test load 420. V_{SRC} 410 is coupled to reference channel 402 at nodes 404, and reference channel 402 is coupled to test load 420 at nodes 406. Test load 420 may be a resistive load or other load. In some embodiments, test load 420 is a load that is specified along with the passing test values and the reference channel. Variable source 410 may include the capability to adjust output parameters such as voltage, delay, jitter, and the like.

In some embodiments, variable source 410 is adjusted such that the measured parameters at the output of the reference channel are at minimally acceptable levels. For example, as shown in FIG. 4, V_{SRC} may be adjusted until V_{EYE} and T_{EYE} are at minimally acceptable levels while reference channel 402 is coupled to test load 420. FIG. 4 shows a single voltage eye that corresponds to a signal having two levels. As described above with reference to FIG. 3, the present invention is not limited to the number of signal levels in the test data pattern. Further, the present invention is not limited to the number or type of parameter measurements made at the output of the reference channel.

Referring now to FIG. 5, the test load has been replaced with receiver under test 510, also referred to as a device under test (DUT). Receiver under test 510 is shown including conductor 512 and receiver circuit 516. Conductor 512 is shown in FIG. 5 to demonstrate that in some embodiments, the test takes into account effects from packaging and interconnects on the integrated circuit die as well as within the package. In some embodiments, receiver under test 510 passes the test if data output on node 530 matches the test data pattern that drives variable source 410.

In some embodiments of the present invention, a receiver may be tested by performing measurements at the output of a reference channel rather than performing measurements directly at the receiver boundary. For example, as shown in FIGS. 4 and 5, receiver under test 510 is tested by first coupling reference channel 402 between variable source 410 and test load 420, and measuring the output of the reference channel. The test load is then replaced with the receiver under test, and the output of the receiver is verified.

Coupling a test load and receiver to a reference channel and performing the measurements as indicated in FIGS. 4 and 5 may be performed in many ways. For example, in some embodiments, a physical channel that corresponds in behavior to the reference channel may be physically coupled between a variable source and a test load. In other embodiments, testing of a receiver may be performed using software simulation. In these embodiments, the reference channel may be specified using a software model such as an s-parameter matrix, and the receiver under test may be specified using a software model created using design automation software. Any combination of simulation and physical measurements may be utilized without departing from the scope of the present invention.

In embodiments using software models, a receiver designer may test the receiver using simulation by coupling reference channel 402 between variable source 410 and test load 420, driving the software models with a test data pattern, and varying variable source 410 until V_{EYE} and T_{EYE} are at minimally acceptable levels. The receiver designer may then replace test load 420 with conductor 512 (to model interconnect effects) and receiver circuit 516 and verify the output of receiver 510.

FIG. 6 shows a diagram of a channel under test and an aggressor channel. The combination of channel under test 602 and aggressor channel 604 demonstrate the effects of crosstalk between channels in a system. For example, when aggressor channel 604 is being driven with a signal, the characteristics of channel under test 602 may change. In this scenario, channel under test 602 may also be referred to as a “victim” channel.

Various characteristics of a victim channel can change as a result of crosstalk from an aggressor channel. For example, the loss versus frequency characteristic may change, and the propagation delay through the channel may change. To model the effects of crosstalk in channel-based testing, various embodiments of the present invention utilize reference channel definitions that incorporate delay specifications as well as loss versus frequency specifications.

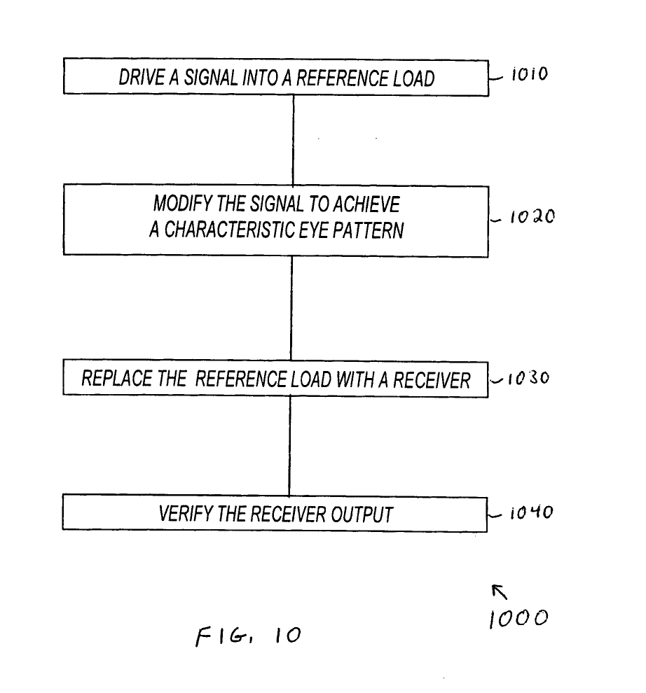

FIG. 7 shows a plot of loss versus frequency, and FIG. 8 shows a plot of delay versus frequency. In FIG. 7, curve 702 shows loss versus frequency, or “insertion loss,” of channel under test 602, and curve 704 shows allowable insertion loss as defined by a reference channel. In some embodiments, curve 704 may be moved up (corresponding to a decreased allowable insertion loss) to take into account possible additional insertion loss caused by crosstalk.

In FIG. 8, curve 802 corresponds to delay through channel under test 602, and curves 804 and 806 shows maximum and minimum delay as defined by one or more reference channels. The range of delay residing between curves 804 and 806 corresponds to acceptable limits for a channel under test. The change in delay through a channel may be caused, in part, by crosstalk.

As shown in FIGS. 7 and 8, one or more reference channels may be defined in terms of both insertion loss and delay. Either or both of these parameter may or may not be a function of frequency. For example, in some embodiments, a reference channel may be defined by a maximum loss and maximum delay or maximum loss and minimum delay. In other embodiments, a reference channel may be defined by a loss versus frequency and maximum delay or loss versus frequency and minimum delay. Further, a reference channel may be defined in part by a delay versus frequency.

In some embodiments, a test may include multiple tests corresponding to multiple reference channel definitions. For example, referring now back to FIG. 3, transmitter 310 may first be tested by coupling a reference channel having a maximum delay and performing measurements at nodes 306. Transmitter 310 may also be tested by coupling a reference channel having a minimum delay and performing measurements at nodes 306. Likewise, receivers may also be tested using multiple reference channel definitions.

FIG. 9 shows a system diagram in accordance with various embodiments of the present invention. FIG. 9 shows system 900 including processor 910, and memory 920. Processor 910 may be a processor that can perform tests in software. For example, processor 910 may perform circuit simulations capable of coupling a reference channel to a device under test, applying a test data pattern, and making measurements. Processor 910 represents any type of processor, including but not limited to, a microprocessor, a personal computer, a workstation, or the like.

Memory 920 represents an article that includes a machine readable medium. For example, memory 920 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by processor 920. Memory 920 can store instructions for performing the execution of the various method embodiments of the present invention.

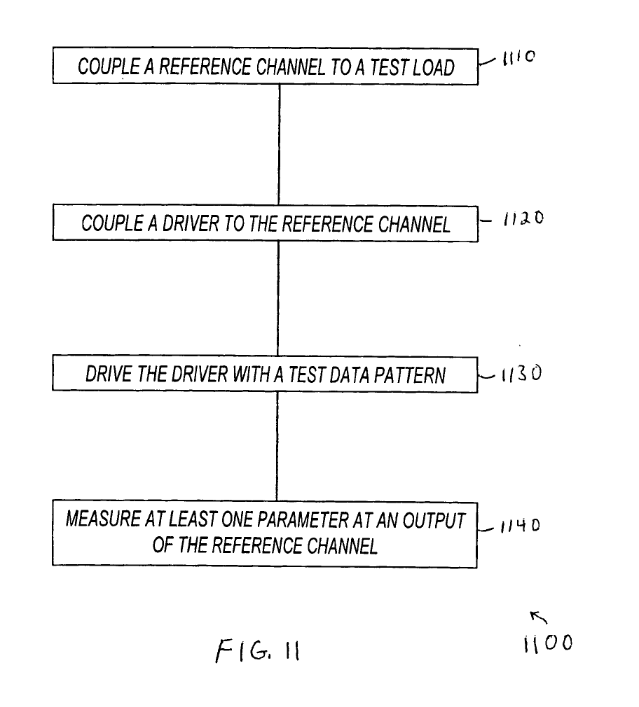

FIG. 10 shows a flowchart in accordance with various embodiments of the present invention. In some embodiments, method 1000 may be used to test a receiver. In some embodiments, method 1000, or portions thereof, is performed by a processor or electronic system, embodiments of which are shown in the various figures. In other embodiments, method 1000 is performed by an automated tester. In some embodiments, method 1000 is performed by a combination of test equipment and human interaction. Method 1000 is not limited by the particular type of apparatus, software element, or person performing the method. The various actions in method 1000 may be performed in the order presented, or may be performed in a different order. Further, in some embodiments, some actions listed in FIG. 10 are omitted from method 1000.

Method 1000 is shown beginning with block 1010 in which a signal is driven into a reference load. In some embodiments, the reference load may be a test load such as test load 420 (FIG. 4). The signal may be generated in many different ways. For example, a signal may be generated by a variable source, and the variable source may be controlled by test equipment, by a computer, or manually by a person. In other embodiments, the signal may be generated by a simulation model as part of a circuit simulation, and the reference load may also be represented by a simulation model as used within the circuit simulation. The signal may be driven through a reference channel, either physically, or through simulation. In some embodiments, the variable source and the reference channel are physically combined into one circuit element, and in other embodiments, they are modeled together in a simulation.

In block 1020, the signal is modified to achieve a characteristic eye pattern. The eye pattern may correspond to a minimally acceptable eye opening when verifying proper operation of a receiver under test. In some embodiments, the eye pattern may be characterized by one or more voltage values, and one or more time values. For example, the characteristic eye pattern may be specified by an eye voltage and an eye time, such as those shown in FIG. 4, that correspond to the minimum acceptable eye opening at the receiver input.

In block 1030, the reference load is replaced with a receiver, and at 1040, the receiver output is verified. In some embodiments, the signal includes alternating data such that the eye pattern substantially repeats. In other embodiments, the signal includes a test data pattern other than alternating data. The test data pattern may be specified to cause worst-case or near worst-case conditions for the characteristic eye patterns. In some embodiments, the test data pattern is a compliance data pattern defined in a specification. In some embodiments, if the receiver output is verified to match the data pattern of the signal, then the receiver passes the test.

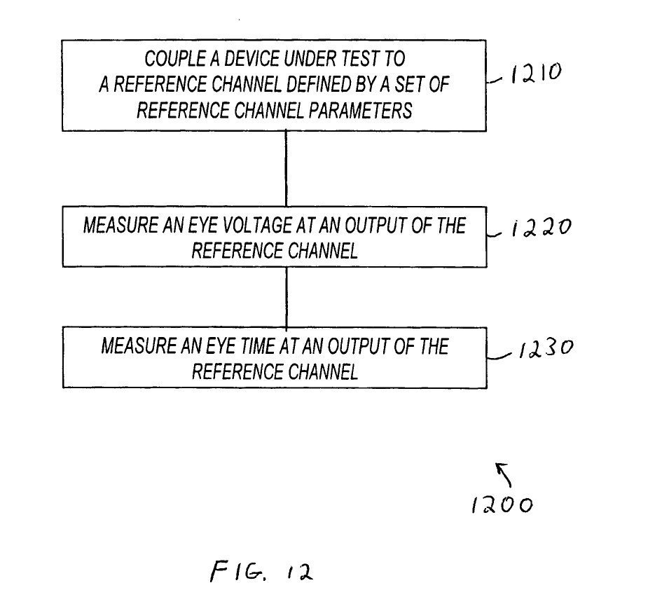

FIG. 11 shows a flowchart in accordance with various embodiments of the present invention. In some embodiments, method 1100 may be used to test a driver or transmitter. In some embodiments, method 1100, or portions thereof, is performed by a processor or electronic system, embodiments of which are shown in the various figures. In other embodiments, method 1100 is performed by an automated tester. In some embodiments, method 1100 is performed by a combination of test equipment and human interaction. Method 1100 is not limited by the particular type of apparatus, software element, or person performing the method. The various actions in method 1100 may be performed in the order presented, or may be performed in a different order. Further, in some embodiments, some actions listed in FIG. 11 are omitted from method 1100.

Method 1100 is shown beginning with block 1110 in which a reference channel is coupled to a test load. In some embodiments, this may correspond to reference channel 302 being coupled to test load 320 (FIG. 3). The reference channel may be a physical reference channel, or may be represented by a set of reference channel parameters. For example, the reference channel may be represented by s-parameters, a loss versus frequency characteristic, minimum delay, maximum delay, or the like.

In block 1120, a driver is coupled to the reference channel. In some embodiments, this may correspond to driver 314 or transmitter 310 being coupled to reference channel 302 (FIG. 3). The driver or transmitter corresponds to the device under test (DUT).

At 1130, the driver is driven with a test data pattern. The test data pattern may include a series of alternating data values, or a test data pattern adapted to produce a worst-case result. As described above, the test data pattern may include digital data with two or more levels. In some embodiments, the test data pattern is a compliance data pattern defined in a specification.

At 1140, at least one parameter is measured at the output of the reference channel. The at least one parameter may include voltage measurements, time measurements, or the like. In some embodiments, the driver under test may be considered as passing the test when the measured parameters are equal to or greater than minimally acceptable levels.

FIG. 12 shows a flowchart in accordance with various embodiments of the present invention. In some embodiments, method 1200 may be used to test a device under test such as a driver, transmitter, or receiver. In some embodiments, method 1200, or portions thereof, is performed by a processor or electronic system, embodiments of which are shown in the various figures. In other embodiments, method 1200 is performed by an automated tester. In some embodiments, method 1200 is performed by a combination of test equipment and human interaction. Method 1200 is not limited by the particular type of apparatus, software element, or person performing the method. The various actions in method 1200 may be performed in the order presented, or may be performed in a different order. Further, in some embodiments, some actions listed in FIG. 12 are omitted from method 1200.

Method 1200 is shown beginning with block 1210 in which a device under test is coupled to a reference channel defined by a set of reference channel parameters. In some embodiments, the device under test includes a transmitter, and in other embodiments, the device under test includes a receiver. The reference channel parameters may include s-parameters, insertion loss characteristics such as loss versus frequency, maximum loss, maximum delay, minimum delay, or the like.

At 1220, an eye voltage is measured at an output of the reference channel. In some embodiments, the eye voltage may correspond to a minimum voltage, a maximum voltage, or a voltage differential corresponding to the height of an eye opening. In some embodiments, multiple eye voltages may be measured. For example, in embodiments that include multi-level signaling, voltage measurements may be made for more than one eye.

At 1230, an eye time is measured at the output of the reference channel. In some embodiments, multiple time measurements are made. For example, a start time and an end time may be measured. In other embodiments, a single time may be measured. For example, a time during which the eye is open may be measured.

The various actions in method 1200 may be utilized to test a variety of types of device under test, including transmitters and receivers. For example, a transmitter may be coupled to a reference channel defined by a set of reference channel parameters, and when the transmitter is driven by a test data pattern, an eye voltage and an eye time may be measured at the output of the reference channel. Also for example, a receiver may be coupled to a reference channel after an eye voltage and an eye time have been measured at the output of the reference channel, while the reference channel is driving a reference load. The receiver may be coupled to reference channel, and the operation of the receiver may then be tested.

In some embodiments, the various actions of methods 1000 (FIG. 10), 1100 (FIG. 11), and 1200 (FIG. 12) may be repeated with more than one reference channel. For example, in some embodiments, a first reference channel may be defined with a maximum delay as one parameter, and a second reference channel may be defined with a minimum delay as one parameter. A single device under test may be tested using multiple reference channels, each having a separate set of reference channel parameters.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method of testing a receiver comprising:
driving a signal into a reference load;
modifying the signal to achieve a characteristic eye pattern;
replacing the reference load with the receiver; and
verifying the receiver output.

2. The method of claim 1 wherein the characteristic eye pattern comprises an eye voltage.

3. The method of claim 1 wherein the characteristic eye pattern comprises an eye time.

4. The method of claim 1 wherein driving the signal into a reference load comprises modeling a driver and reference channel.

5. A method of testing a driver comprising:
driving a reference channel; and
measuring at least one parameter at an output of the reference channel.

6. The method of claim 5 wherein the method is performed by computer simulation.

7. The method of claim 6 wherein the reference channel is specified by s-parameters.

8. The method of claim 6 wherein the reference channel is specified at least in part by a loss versus frequency characteristic.

9. The method of claim 8 wherein the reference channel is further specified by a minimum delay.

10. The method of claim 8 wherein the reference channel is further specified by a maximum delay.

11. The method of claim 5 wherein the at least one parameter includes an eye voltage.

12. The method of claim 5 wherein the at least one parameter includes an eye time.

13. The method of claim 5 wherein the reference channel is specified at least in part by a delay versus frequency characteristic.

14. A method comprising:
coupling a device under test to a reference channel; and
measuring at least one parameter at an output of the reference channel.

15. The method of claim 14 wherein the device under test comprises a receiver.

16. The method of claim 14 wherein the device under test comprises a driver.

17. The method of claim 14 wherein the at least one parameter comprises an eye voltage.

18. The method of claim 14 wherein the at least one parameter comprises an eye time.

19. The method of claim 14 wherein the method is performed by computer simulation.

20. The method of claim 19 wherein the reference channel is defined by a set of reference channel parameters.

21. The method of claim 20 wherein the set of reference channel parameters comprises s-parameters.

22. The method of claim 20 wherein the set of reference channel parameters comprises a loss value.

23. The method of claim 22 wherein the set of reference channel parameters further comprises a delay value.

24. An apparatus including a medium adapted to hold machine-accessible instructions that when accessed result in a machine performing:
coupling a device under test to a reference channel; and
measuring at least one parameter at an output of the reference channel.

25. The apparatus of claim 24 wherein the device under test comprises a receiver.

26. The apparatus of claim 24 wherein the device under test comprises a driver.

27. The apparatus of claim 24 wherein the at least one parameter comprises an eye time.

28. An electronic system comprising:
a processor capable of simulating a circuit; and
an SRAM storage medium accessible by the processor, the storage medium to hold instructions that when accessed result in the processor performing:
coupling a device under test to a reference channel; and
measuring at least one parameter at an output of the reference channel.

29. The electronic system of claim 28 wherein the device under test comprises a receiver.

30. The electronic system of claim 28 wherein the device under test comprises a driver.
